(19) United States
(12) Patent Application Publication
(10) Pub. No.: US 2016/0107342 A1
(43) Pub. Date: Apr. 21, 2016

(54) METAL-AND-RESIN COMPOSITE AND METHOD FOR MAKING SAME

(71) Applicants: SHENZHEN FUTAIHONG PRECISION INDUSTRY CO., LTD., Shenzhen (CN); FIH (HONG KONG) LIMITED, Kowloon (HK)

(72) Inventors: CHWAN-HWA CHIANG, New Taipei (TW); CHIEH-HSIANG WANG, New Taipei (TW); BAO-SHEN ZHANG, Shenzhen (CN)

(21) Appl. No.: 14/595,443

(22) Filed: Jan. 13, 2015

(30) Foreign Application Priority Data
Oct. 20, 2014 (CN) 201410558391.9

(51) Int. Cl. B29C 37/00; B29C 70/68; B29C 70/78; C25D 5/48

(52) U.S. Cl. CPC B29C 37/0078; C25D 5/48; B29C 70/683; B29C 70/78; B29K 2705/00

(57) ABSTRACT

A metal-resin composite includes a metal member and a resin member, the metal member has a plurality of metal posts formed on a surface of the metal member, the resin member is filled spaces between adjacent metal posts and covers the surface of the metal member to bond with the metal member.

### FIELD

The subject matter herein generally relates to a metal-and-resin composite and a method for making the metal-and-resin composite.

### BACKGROUND

Integrated metals and synthetic resins are used in a wide range of industrial fields including the production of parts for automobiles, domestic appliances, industrial machinery, and the like. Generally, the metal and the resin are joined together by adhesive. However, this method cannot supply a high-strength composite of metal and resin. There is a need to bond metal and resin together.

### BRIEF DESCRIPTION OF THE FIGURES

Implementations of the present technology will now be described, by way of example only, with reference to the attached figures.

FIG. 1 is a cross-sectional view of a first exemplary embodiment of a metal-and-resin composite.

FIG. 2 is a cross-sectional view of a second exemplary embodiment of a metal-and-resin composite.

FIG. 3 is a cross-sectional view of a third exemplary embodiment of a metal-and-resin composite.

FIG. 4 is a cross-sectional view of a fourth exemplary embodiment of a metal-and-resin composite.

FIG. 5 is a cross-sectional view of a fifth exemplary embodiment of a metal-and-resin composite.

FIG. 6 is a flowchart of a method for making a metal-and-resin composite in accordance with a first exemplary embodiment.

FIG. 7 is a flowchart of a method for making a metal-and-resin composite in accordance with a second exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented. The term “comprising” when utilized, means “including, but not necessarily limited to”; it specifically indicates open-ended inclusion or membership in the so-described combination, group, series and the like.

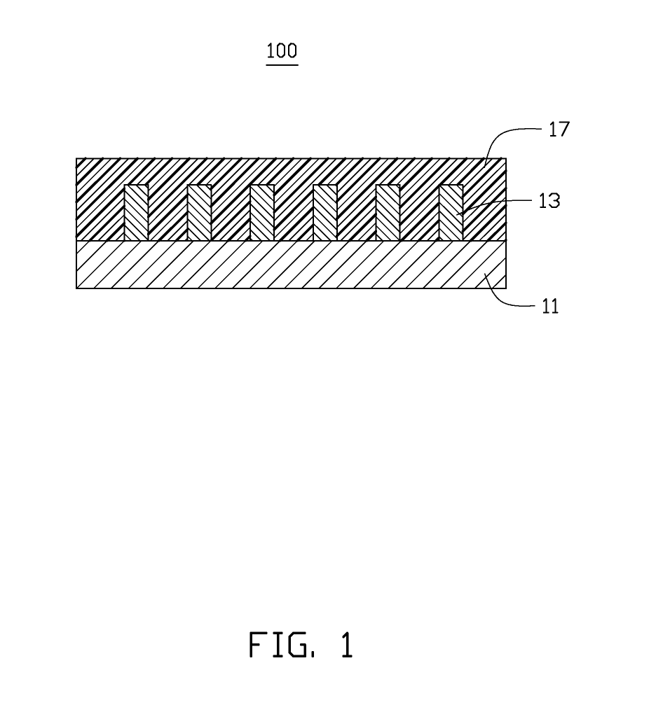

FIG. 1 illustrates a metal-and-resin composite 100 according to a first exemplary embodiment. The composite 100 can include a metal member 11, a plurality of metal posts 13 formed on the metal member 11 and a resin member 17 formed on the metal member 11 and the metal posts 13.

The metal member 11 can be selected from a group consisting of stainless steel, aluminum, aluminum alloy, magnesium, magnesium alloy, copper, copper alloy, zinc and zinc alloy.

Each metal post 13 has a diameter of about 0.01 mm to about 1 mm, a length of about 2 μm to about 15 μm along a direction extending from the metal member 11 to the resin member 17. The metal posts 13 can be selected from a group consisting of Au, Ag, Cu, Ni, Zn, Sn, Al and Cr. In at least one exemplary embodiment, the metal posts 13 can be made of Ni.

The metal posts 13 can have a dense structure. The surface of each metal post 13 is smooth and glossy, such that the metal posts 13 are shiny.

It is to be understood, however, the shiny metal posts 13 can have different lengths and diameters such that the metal posts 13 can have very irregular surface and different shapes.

The resin member 17 can be coupled to the spaces located between adjacent metal posts 13 and cover the surface of the metal member 11, such that the resin member 17 can strongly bond with the metal member 11.

The resin member 17 can be made of a thermoplastic or a thermosetting plastic.

The thermoplastic can be selected from a group consisting of polybutylene terephthalate (PBT), polyphenylene sulfide (PPS), polyethylene terephthalate (PET), polyether ether ketone (PEEK), polycarbonate (PC) and polyvinyl chloride polymer (PVC).

The thermosetting plastic can be selected from a group consisting of polyurethane resin, epoxy, polyurea resin and acrylic resin.

The polyurethane resin can be referred to an organic compound having a plurality of —NHCOO groups at the main chain of the organic compound, or a product of an addition polymerization reaction between a diisocyanate or polyisocyanate and a compound having at least two hydroxides. Besides the —NHCOO groups, the polyurethane resin can also have other groups, such as C—O—C groups, C—O—O—C groups, N—CO—N groups, biuret groups, allophanate groups, and so on.

The epoxy can be referred to an organic compound having at least two epoxy groups.

The polyurea resin can be referred to as an elastomer formed by a reaction between an isocyanate and a resin. The polyurea resin can be an aliphatic compound, an aromatic compound, a monomer, a polymer, a derivative of isocyanate, a semi-prepolymer of isocyanate or a prepolymer of isocyanate. The semi-prepolymer of isocyanate and the prepolymer of isocyanate can be made by a reaction between an isocyanate and a compound having an amino group or a hydroxy group at one terminal of the compound.

The acrylic resin can have at least two groups, and can be cured by a UV cross-linking reaction.

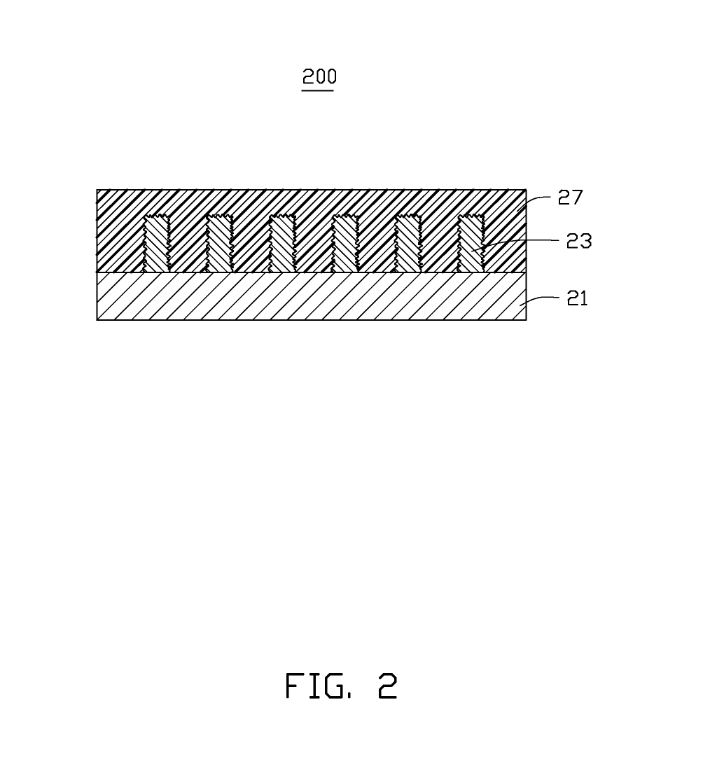

FIG. 2 illustrates a metal-and-resin composite 200 according to a second exemplary embodiment.

The difference between the composite 200 of the second exemplary embodiment and the composite 100 of the first exemplary embodiment is that the surface of each metal post 23 of the second exemplary embodiment is not smooth and glossy. The metal posts 23 can have a diameter of about 0.01 mm to about 1 mm, a length of about 2 μm to about 20 μm along a direction extending from the metal member 21 to the resin member 27. The surface roughness of the metal posts 23 can be 2 μm to about 5 μm.

It is to be understood, however, the metal posts 23 of the second exemplary embodiment can have the different lengths and diameters, such that the metal posts 23 can have a very irregular surface and different shapes.

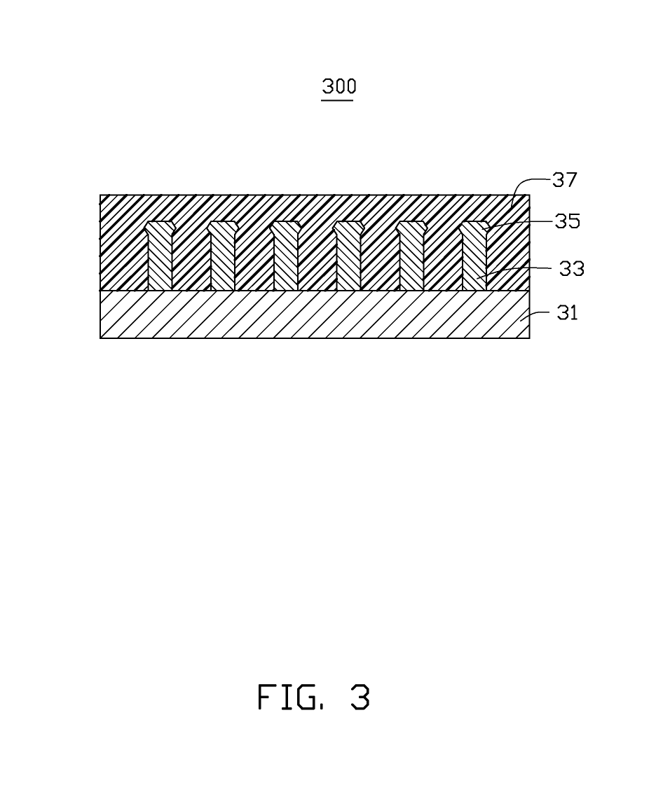

FIG. 3 illustrates a metal-and-resin composite 300 according to a third exemplary embodiment.

The difference between the composite 300 of the third exemplary embodiment and the composite 100 of the first exemplary embodiment is that one end of each metal post 33 away from the metal member 31 may further have a metal lug 35 perpendicularly connected with the corresponding metal post 33. The surface of each metal lug 35 is smooth and glossy, such that the metal lugs 35 are shiny. The thickness of each metal lug 35 can be about 4 μm to about 8 μm. The metal lugs 35 can be selected from a group consisting of Au, Ag, Cu, Ni, Zn, Sn, Al and Cr. In at least one exemplary embodiment, the metal lugs 35 can be made of Ni. The resin member 37 can be located at the spaces between adjacent metal posts 33, and cover the surface of the metal member 31 and the metal lugs 35. The metal posts 33 and the metal lugs 35 can fix the resin member 37 on the metal member 31, such that the resin member 37 can strongly bond with the metal member 31.

It is to be understood, however, the metal lugs 35 of the third exemplary embodiment can have the different thicknesses and diameters, such that the metal lugs 35 can have a very irregular surface and different shapes. The metal posts 33 of the third exemplary embodiment can have the different lengths and diameters, such that the metal posts 33 can have a very irregular surface and different shapes.

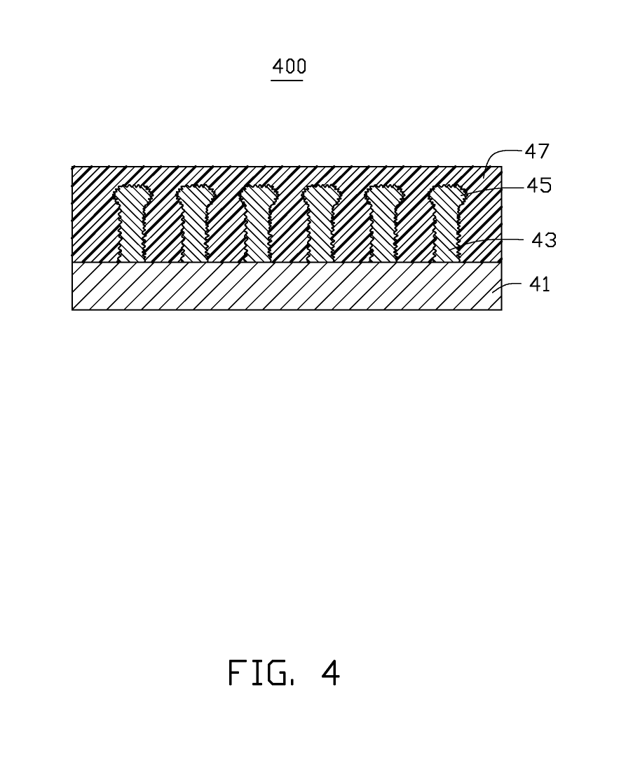

FIG. 4 illustrates a metal-and-resin composite 400 according to a fourth exemplary embodiment.

The difference between the composite 400 of the fourth exemplary embodiment and the composite 200 of the second exemplary embodiment is that one end of each metal post 43 away from the metal member 41 may further have a metal lug 45 perpendicular connected with the corresponding metal post 43. The surface of each metal lug 45 is not smooth and glossy, such that the metal lugs 45 are foggy. The thickness of each metal lug 45 can be about 4 μm to about 8 μm. The surface roughness of the metal lugs 45 can be about 2 μm to about 5 μm. The metal lug 45 can be selected from a group consisting of Au, Ag, Cu, Ni, Zn, Sn, Al and Cr. In at least one exemplary embodiment, the metal lugs 45 can be made of Ni. The resin member 47 can be located at the spaces between adjacent metal posts 43, and cover the surface of the metal member 41 and the metal lugs 45. The metal posts 43 and the metal lugs 45 can fix the resin member 47 on the metal member 41, such that the resin member 41 can strongly bond with the metal member 41. The roughness structure of the metal posts 43 and the metal lugs 45 can further enhance the bonding between the resin member 47 and the metal member 41.

In at least one exemplary embodiment, the metal lugs 45 can be made of Ni. It is to be understood, however, the metal lugs 45 of the fourth exemplary embodiment can have the different thickness and diameters, such that the metal lugs 45 can have very irregular surface and different shapes. The metal posts 43 of the fourth exemplary embodiment can also have the different lengths and diameters, such that the metal posts 43 can have a very irregular surface and different shapes.

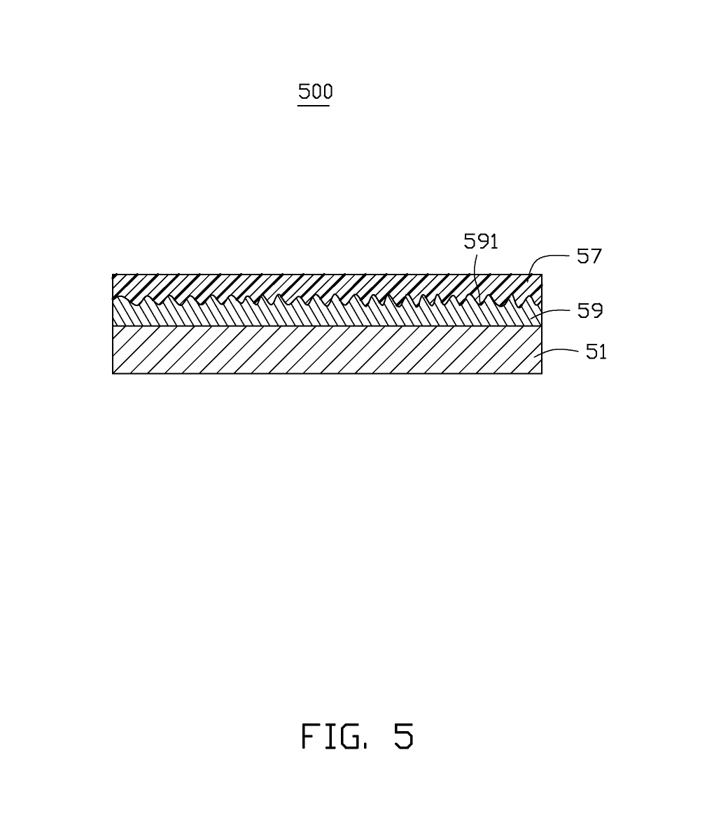

FIG. 5 illustrates a metal-and-resin composite 500 according to a fifth exemplary embodiment. The composite 500 according to the fifth exemplary embodiment can include a metal member 51, a metal layer 59 formed on the metal member 51, and a resin member 57 formed on the metal layer 59.

The metal member 51 can be selected from a group consisting of stainless steel, aluminum, aluminum alloy, magnesium, magnesium alloy, copper, copper alloy, zinc, and zinc alloy.

The metal layer 59 may have a surface roughness of about 2 μm to about 5 μm. The thickness of the metal layer 59 can be about 2 μm to about 20 μm. The metal layer 59 can have a plurality of micro-pores 191, the diameter of the micro-pores 191 can be less than about 100 μm, and preferrably about 1 μm to about 50 μm.

The metal layer 59 can be made of metal which can be selected from a group consisting of Au, Ag, Cu, Ni, Zn, Sn, Al and Cr. In at least one exemplary embodiment, metal layer 59 can be made of Ni.

The resin member 57 can be made of a thermoplastic or a thermosetting plastic.

The thermoplastic can be selected from a group consisting of polybutylene terephthalate (PBT), polyphenylene sulfide (PPS), polyethylene terephthalate (PET), polyether ether ketone (PEEK), polycarbonate (PC) and polyvinyl chloride polymer (PVC).

The thermosetting plastic can be selected from a group consisting of polyurethane resin, epoxy, polyurea resin and acrylic resin.

The polyurethane resin can be referred to an organic compound having a plurality of —NHCOO groups at the main chain of the organic compound, or a product of an addition polymerization reaction between a diisocyanate or polyisocyanate and a compound having at least two hydroxides. Besides the —NHCOO groups, the polyurethane resin also has other groups, such as C—O—C groups, C—O—O—C groups, N—CO—N groups, biuret groups, allophanate groups, and so on.

The epoxy can be referred to an organic compound having at least two epoxy groups.

The polyurea resin can be referred to as an elastomer formed by a reaction between an isocyanate and a resin. The polyurea resin can be an aliphatic compound, an aromatic compound, a monomer, a polymer, a derivative of isocyanate, a semi-prepolymer of isocyanate or a prepolymer of isocyanate. The semi-prepolymer of isocyanate and the prepolymer of isocyanate can be made by a reaction between an isocyanate and a component having an amino group or a hydroxy group at one terminal of the component.

The acrylic resin can have at least two groups, and can be cured by a UV cross-linking reaction.

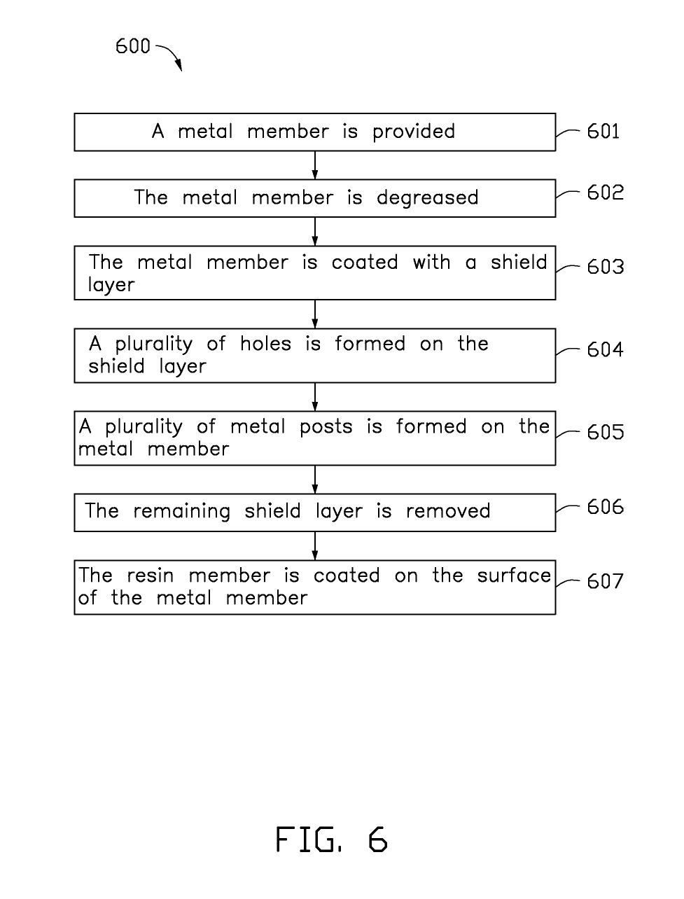

Referring to FIG. 6, a flowchart is presented in accordance with a first example embodiment. The method 600 is provided by way of example, as there are a variety of ways to carry out the method. The method 600 described below can be carried out using the configurations illustrated in FIGS. 1-4, for example, and various elements of these figures are referenced in explaining example method 600. Each block shown in FIG. 6 represents one or more processes, methods or subroutines, carried out in the example method 600. Furthermore, the illustrated order of blocks is illustrative only and the order of the blocks can change according to the present disclosure. Additional blocks may be added or fewer blocks may be utilized, without departing from this disclosure. The example method 600 can begin at block 601.

At block 601, a metal member 11, 21, 31, 41 is provided. The metal member 11, 21, 31, 41 can be made by casting, punching, or computer number control. The metal member 11, 21, 31, 41 can be made of metal which can be selected from a group consisting of stainless steel, aluminum, aluminum alloy, magnesium, magnesium alloy, copper, copper alloy, zinc and zinc alloy.

At block 602, the metal member 11, 21, 31, 41 is degreased. The degreasing process may include dipping the metal member 11, 21, 31, 41 in a degreasing solution for about 1 minute to about 6 minutes. The degreasing solution may be a conventional degreasing solution having a concentration of about 90-150 g/L. The temperature of the degreasing solution may be about 20° C. to about 60° C. Then, the metal member 11, 21, 31, 41 is removed from the degreasing solution and rinsed in water.

At block 603, a shield layer (not shown) is formed on the metal member 11, 21, 31, 41. The shield layer can be formed by either of the following two methods:

In a first method, a polyurethane paint can be sprayed onto the metal member 11, 21, 31, 41. And then the metal member 11, 21, 31, 41 coated with polyurethane paint can be put into a dryer to be dried a temperature of about 70° C. to about 90° C., the drying process may last for about 8 minutes to about 15 minutes, forming the shield layer having a thickness of about 10 μm to about 20 μm.

In a second method, the shield layer can be formed by an electrophoretic process. The electrophoretic process can be carried out in an electrophoresis bath at a temperature of about 30° C. to about 35° C. with the metal member 11, 21, 31, 41 being an anode, and a stainless steel board being a cathode. The voltage between the anode and the cathode can be about 70 V to about 90 V. The electrophoresis bath may include electrophoretic paint and water. A volume ratio referring to electrophoretic paint/water can be about 3-5:4-6. The electrophoretic paint can be an epoxy electrophoretic paint. The main chain of the epoxy electrophoretic paint can have polyether and diol alcohol, polyether and diamine, or polyester and diol alcohol.

At block 604, a plurality of holes (not shown) is formed on the shield layer by a laser engraving process. The laser engraving process can be carried out by emitting a laser from a laser marking machine on a surface of the shield layer to form a hole (not shown) having a diameter of about 0.01 mm to about 0.1 mm, such that the metal member 11, 21, 31, 41 can be partly exposed from the shield layer. The wavelength of the laser can be about 1064 nm. The powder of the laser marking machine can be about 10 KW to about 20 KW, the frequency of the laser marking machine can be about 30 KHZ to about 40 KHZ, the filling space can be about 0.01 mm to about 0.1 mm, the effective time step can be about 0.005 mm/s, and the marking speed can be less than 9000 mm/s.

After the hole is formed, the laser emitting direction can be changed by an operating system of the laser marking machine, then the laser having a different direction can be focused on the surface of the shield layer to form another hole (not shown) having a diameter of about 0.01 mm to about 0.1 mm, such that the metal member 11, 21, 31, 41 can be partly exposed from the shield layer. The cycle can be repeated continuously, such that the shield layer can form a plurality of holes. The time of forming each hole can be about 0.3 seconds to about 1 second. Parts of metal member 11, 21, 31, 41 can be exposed from the shield layer by the holes, so that the metal member 11, 21, 31, 41 having the shield layer having holes can be conductive.

At block 605, a plurality of metal posts 13, 23, 33, 43 can be formed on the metal member 11, 21, 31, 41. The metal posts 13, 23, 33, 43 can be formed by either of the following two methods:

In a first method, the metal posts 13, 23, 33, 43 can be formed by an electronic plating process. The electronic plating process can be carried out in an electrolytic solution at about 50° C. to about 60° C. with a nickel ball being an anode and the metal member 11, 21, 31, 41 being a cathode. The electric current density through the electrolytic solution is about 2 to about 8.5 amperes per square decimeter (A/dm2). The time between the time of pulse current frequency pass (ON) can be about 60 ms to about 90 ms and the time of the pulse current frequency off (OFF) referring to ON/OFF can be about 10 ms to about 40 ms. The electrolytic solution should be stirred by inletting compressed air into the electrolytic solution. The electronic plating process may last for about 10 minutes to about 20 minutes to form a plurality of nickel metal posts 13, 23, 33, 43 in the holes, such that the surface of the metal member 11, 21, 31, 41 exposed from the shield layer can have a plurality of metal posts 13, 23, 33, 43.

The nickel metal posts 13, 23, 33, 43 having good anti-corrosion property can strongly adhere to the metal member 11, 21, 31, 41. The metal posts 13, 23, 33, 43 can have a dense structure. Each surface of the metal posts 13, 23, 33, 43 is smooth and glossy, such that the metal posts 13, 23, 33, 43 are shiny. The metal posts 13, 23, 33, 43 can have a diameter of about 0.01 mm to about 1 mm, a length of about 5 μm to about 15 μm along a direction extending from the metal member 11, 21, 31, 41 to the resin member 17, 27, 37, 47.

The electrolytic solution may include a nickel salt having a concentration of about 280 g/L to about 450 g/L, nickel chloride having a concentration of about 50 g/L to about 70 g/L, boric acid having a concentration of about 30 g/L to about 40 g/L, a softener having a concentration of about 5 ml/L to about 8 ml/L, a gloss agent having a concentration of about 0.1 ml/L to about 0.3 ml/L, and a wetting agent having a concentration of about 1 ml/L to about 2 ml/L.

The nickel salt can be nickel sulfate or nickel sulfaminate. When the nickel salt is nickel sulfate, the concentration of the nickel sulfate can be about 280 g/L to about 350 g/L. When the nickel salt is nickel sulfaminate, the concentration of the nickel sulfaminate can be about 380 g/L to about 450 g/L. The nickel chloride can enhance the electric conductivity of the electrolytic solution, and dissolution rate of the nickel ball. The boric acid can prevent the metal posts 13, 23, 33, 43 from coking, spalling, peeling and fogging.

The gloss agent can be selected from a group consisting of benzene sulfonamide, benzene disulfonic acid, benzene trisulfonic acid, and napthalene trisulfonic acid. The gloss agent can make the surface of the metal posts 13, 23, 33, 43 smooth and glossy, such that the metal posts 13, 23, 33, 43 are shiny.

The softener can be selected from a group consisting of formaldehyde, coumarin, ethylene cyanohydrins and butynediol. The softener can also make the surface of the metal posts 13, 23, 33, 43 smooth and glossy.

The wetting agent can be selected from a group consisting of poly ethylene glycol (PEG) having a molecular weight of about 6000, 8000 or 10000, sodium dodecyl sulfonate, modified polyether (HFI), ethylene oxide propylene oxide copolymer, alkyl phenol polyoxyethylene ether sulfonate, or a polyamine surfactant. The polyamine surfactant can be fatty amine polyoxyethylene ether or alkoxy bis amine polyoxyethylene ether. The wetting agent can reduce the interfacial tension between the electrode and the electrolytic solution, such that the electrolytic solution can be easily spread out on the surface of the electrode.

In a second method, the metal posts 13, 23, 33, 43 can be formed by a chemical plating process. The chemical plating process can be carried out in chemical solution having a pH of about 6 to about 6.5. The chemical solution comprising nickel sulfate having a concentration of about 10 g/L to about 20 g/L, sodium hypophosphite having a concentration of about 10 g/L to about 15 g/L, ammonium acid fluoride having a concentration of about 26 g/L to about 33 g/L, sodium citrate having a concentration of about 11 g/L to about 17 g/L, and lactic acid having a concentration of about 2 g/L to about 3 g/L. The metal member 11, 21, 31, 41 can be dipped into the chemical solution at a temperature of about 60° C. to about 90° C., and the dipping process may last for about 1 minute to about 5 minutes to form a plurality of nickel metal posts 13, 23, 33, 43 on the surface of the metal member 11, 21, 31, 41 exposed from the shield layer. In the chemical plating process, the metal member 11, 21, 31, 41 should be swung. The frequency of the swing can be about 10 times per minutes to about 20 times per minutes. The forming rate of the metal posts 13, 23, 33, 43 in the chemical plating may have some relationship with the pH value and the temperature of the chemical solution. A predetermined amount of ammonia should be added into the chemical solution to keep the pH at about 6 to about 6.5.

It is to be understood, the metal posts 13, 23, 33, 43 can also be made of another metal by changing the chemical solution or the electrolytic solution. The metal can be selected from a group consisting of Au, Ag, Cu, Zn, Sn, Al and Cr.

At block 606, the remaining shield layer is removed by dipping the metal member 11, 21, 31, 41 into a paint remover solution at the temperature of about 50° C. to about 70° C. The dipping process may last for about 5 minutes to about 15 minutes. The paint remover solution can be a conventional paint remover solution. In at least one exemplary embodiment, the model of paint remover solution can be T35 sold by ShenZhen HongDaWei Co. Ltd.

At block 607, the metal member 11, 21, 31, 41 having the metal posts 13, 23, 33, 43 is put into a mold (not shown). Liquid resin can be filled into the spaces between adjacent metal posts 13, 23, 33, 43 and cover the surface of the metal member 11, 21, 31, 41, forming the resin member 17, 27, 37, 47. The metal member 11, 21, 31, 41, metal posts 13, 23, 33, 43 and the resin member 17, 27, 37, 47 cooperatively form the composite 100-400. The metal posts 13, 23, 33, 43 formed on the metal member 11, 21, 31, 41 can enhance the bonding between the metal member 11, 21, 31, 41 and the resin member 17, 27, 37, 47. The injection pressure is about 2 bar to about 4 bar, and the temperature of the resin during the injection process can be maintained at about 290° C. to about 320° C. The thickness of the resin member 17, 27, 37, 47 can be changed according to the need of the composite 100-400.

The resin member 17, 27, 37, 47 can be made of a thermoplastic or a thermosetting plastic.

The thermoplastic can be selected from a group consisting of polybutylene terephthalate (PBT), polyphenylene sulfide (PPS), polyethylene terephthalate (PET), polyether ether ketone (PEEK), polycarbonate (PC) and polyvinyl chloride polymer (PVC).

The thermosetting plastic can be selected from a group consisting of polyurethane resin, epoxy, polyurea resin and acrylic resin.

The polyurethane resin can be referred to an organic compound having a plurality of —NHCOO groups at the main chain of the organic compound, or a product of an addition polymerization reaction of a diisocyanate or polyisocyanate with a compound having at least two hydroxides. Besides the —NHCOO groups, the polyurethane resin also has groups, such as C—O—C groups, C—O—O—C groups, N—CO—N groups, biuret groups, allophanate groups, and so on.

The epoxy can be referred to an organic compound having at least two epoxy groups.

The polyurea resin can be referred to as an elastomer formed by a reaction of an isocyanate with a resin. The polyurea resin can be an aliphatic compound, an aromatic compound, a monomer, a polymer, a derivative of isocyanate, a semi-prepolymer of isocyanate or a prepolymer of isocyanate. The semi-prepolymer of isocyanate and the prepolymer of isocyanate can be made by a reaction of an isocyanate with a component having an amino group or a hydroxy group at one terminal of the component.

The acrylic resin can have at least two groups, and can be cured by a UV cross-linking reaction.

It is to be understood, a defined amount of curing agent or photo-initiator should be added into the thermosetting plastic when the resin member 17, 27, 37, 47 is made of the thermosetting plastic. When liquid thermosetting plastic having curing agent or photo-initiator is filled into the spaces between adjacent metal posts 13, 23, 33, 43 and covers the surface of the metal member 11, 21, 31, 41, the thermosetting plastic can be hardened, forming the resin member 17, 27, 37, 47.

The difference between the method of making the metal posts 23 according to a second exemplary embodiment and the method of making the metal posts 13 according to the first exemplary embodiment can be the method of making the metal posts 23. The metal posts 23 according to the second exemplary embodiment can be formed by an electroplating process. The electroplating process can be carried out in an electrolytic solution at about 50° C. to about 60° C. with a nickel ball being an anode and the metal member 21 being a cathode. The electric current density through the electrolytic solution is about 0.3 amperes to about 5 amperes per square decimeter (A/dm²). The time between the time of pulse current frequency pass (ON) can be about 990 ms to about 999 ms and the time of the pulse current frequency off (OFF) referring to ON/OFF can be about 1 ms to about 10 ms. The electrolytic solution should be stirred by inletting compressed air into the electrolytic solution. The electronic plating process may last for about 10 minutes to about 20 minutes to form a plurality of nickel metal posts 23 on the surface of the metal member 21 exposed from the shield layer.

The electrolytic solution can include a nickel salt having a concentration of about 280 g/L to about 450 g/L, a nickel chloride having a concentration of about 50 g/L to about 70 g/L, a boric acid having a concentration of about 30 g/L to about 40 g/L. The nickel salt can be nickel sulfate or nickel sulfaminate. When the electrolytic solution includes the nickel sulfate, the concentration of the nickel sulfate can be about 280 g/L to about 350 g/L. When the electrolytic solution includes the nickel sulfaminate, the concentration of the nickel sulfaminate can be about 380 g/L to about 450 g/L. The nickel chloride can enhance the electric conductivity of the electrolytic solution, and dissolution rate of the nickel ball. The boric acid can prevent the metal posts 23 from coking, spalling, peeling and fogging.

The surface of each metal post 23 of the second exemplary embodiment is not smooth and glossy, such that the metal posts 23 is foggy. The metal posts 23 can have a diameter of about 0.01 mm to about 1 mm, a length of about 2 μm to about 20 μm along a direction extending from the metal member 21 to the resin member 27. The surface roughness of the foggy metal posts 23 can be 2 μm to about 5 μm.

The difference between the method of making the metal posts 33 according to a third exemplary embodiment and the method of making the metal posts 13 according to the first exemplary embodiment can be that one end of each metal post 33 away from the metal member 31 may further have a metal lug 35 perpendicular connected with the corresponding metal post 33. The metal lugs 35 according to the third exemplary embodiment can be formed on an end of each metal post 33 away from the metal member 31 by an electronic plating process or a chemical plating process as illustrated at block 605. The surface of each metal lug 35 is smooth and glossy, such that the metal lugs 35 are shiny. The thickness of each metal lug 35 can be about 4 μm to about 8 μm. The metal lugs 35 can be selected from a group consisting of Au, Ag, Cu, Ni, Zn, Sn, Al and Cr. In at least one exemplary embodiment, the metal lug 35 can be made of Ni. The resin member 37 can be located at the spaces between the adjacent metal posts 33 and cover the surface of the metal member 31 and the metal lugs 35 to bond with the metal member 31. The metal posts 33 and the metal lugs 35 can fix the resin member 37 on the metal member 31, such that the resin member 37 can strongly bond with the metal member 31.

The difference between the method of making the metal posts 43 according to a fourth exemplary embodiment and the method of making the metal posts 23 according to the second exemplary embodiment can be that one end of each metal post 43 away from the metal member 41 may further have a metal lug 45 perpendicular connected with the corresponding metal post 43. The metal lugs 45 according to the fourth exemplary embodiment can be formed on an end of each metal post 43 away from the metal member 41 by an electroplating process or a chemical plating process as illustrated in the second exemplary embodiment. The surface of each metal lug 45 is not smooth and glossy, such that the metal lugs 45 are foggy. The thickness of each metal lug 45 can be about 4 μm to about 8 μm. The surface roughness of the foggy metal lug 45 can be about 2 μm to about 5 μm. The metal lug 45 can be selected from a group consisting of Au, Ag, Cu, Ni, Zn, Sn, Al and Cr. In at least one exemplary embodiment, the metal lug 45 can be made of Ni. The resin member 47 can be located at the spaces between the two adjacent metal posts 43, and coated on the surface of the metal member 41 and the metal lugs 45 to bond with the metal member 41. The metal posts 43 and the metal lugs 45 can fix the resin member 47 on the metal member 41, such that the resin member 47 can strongly bond with the metal member 41. The roughness structure of the metal posts 43 and the metal lugs 45 can further enhance the bonding between the resin member 47 and the metal member 41.

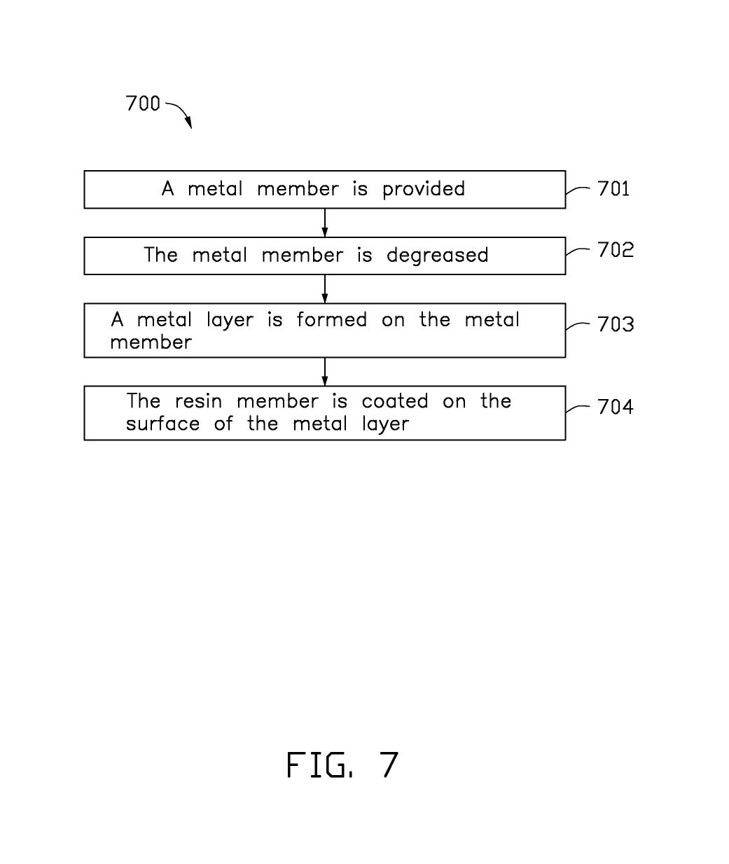

Referring to FIG. 7, a flowchart is presented in accordance with a fifth example embodiment. The method 700 is provided by way of example, as there are a variety of ways to carry out the method. The method 700 described below can be carried out using the configurations illustrated in FIG. 5, for example, and various elements of these figures are referenced in explaining example method 700. Each block shown in FIG. 7 represents one or more processes, methods or subroutines, carried out in the example method 700. Furthermore, the illustrated order of blocks is illustrative only and the order of the blocks can change according to the present disclosure. Additional blocks may be added or fewer blocks may be utilized, without departing from this disclosure. The example method 700 can begin at block 701.

At block 701, a metal member 51 is provided. The metal member 51 can be made by casting, punching, or computer number control. The metal member 51 can be made of metal which can be selected from a group consisting of stainless steel, aluminum, aluminum alloy, magnesium, magnesium alloy, copper, copper alloy, zinc and zinc alloy.

At block 702, the metal member 51 is degreased. The degreasing process may include dipping the metal member 51 in a degreasing solution for about 1 minute to about 6 minutes. The degreasing solution may be a conventional degreasing solution. The degreasing solution in this embodiment may have a concentration of about 90-150 g/L. The temperature of the degreasing solution may be about 20° C. to about 60° C. Then, the metal member 51 is removed from the degreasing solution and rinsed in water.

At block 703, a metal layer 19 is formed on the metal member 51 by an electroplating process. The electroplating process can be carried out in an electrolytic solution at about 50° C. to about 60° C. with a nickel ball being an anode and the metal member 51 being a cathode. The electric current density through the electrolytic solution is about 0.3 ampere to about 5 amperes per square decimeter (A/dm²). The time ratio between the time of pulse current frequency pass (ON) can be about 990 ms to about 999 ms and the time of the pulse current frequency off (OFF) referring to ON/OFF can be about 1 ms to about 10 ms. The electrolytic solution should be stirred by inletting compressed air into the electrolytic solution. The electroplating process may last for about 10 minutes to about 20 minutes to form a metal layer 59 having a surface roughness of about 2.0 μm to about 5.0 μm on the surface of the metal member 51. The surface roughness can enhance the bonding between the metal layer 59 and the resin member 57.

The metal layer 59 can have a plurality of micro-pores 591. The diameter of micro-pores 591 can be less than 100 μm, and preferrably about 1 μm to about 50 μm.

The electrolytic solution can include a nickel salt having a concentration of about 280 g/L to about 450 g/L, nickel chloride having a concentration of about 50 g/L to about 70 g/L, boric acid having a concentration of about 30 g/L to about 40 g/L. The nickel salt can be nickel sulfate or nickel sulfaminate. When the nickel salt is nickel sulfate, the concentration of the nickel sulfate can be about 280 g/L to about 350 g/L. When the nickel salt is nickel sulfaminate, the concentration of the nickel sulfaminate can be about 380 g/L to about 450 g/L. The nickel chloride can enhance the electric conductivity of the electrolytic solution, and dissolution rate of the nickel ball. The boric acid can prevent the metal posts 53 from coking, spalling, peeling and fogging.

It is to be understood, the metal layer 19 can also be made of another metal by changing the electrolytic solution. The metal can be selected from a group consisting of Au, Ag, Cu, Zn, Sn, Al and Cr.

At block 704, the metal member 51 having the micro-pores 591 can be put into a mold (not shown). Liquid resin can be filled into the micro-pores 591 and cover the surface of the metal layer 59, forming the resin member 57. The metal member 51, the metal layer 59, and the resin member 57 cooperatively form the composite 500. The micro-pores 591 formed on the metal layer 59 can enhance the combination between the metal member 51 and the resin member 57. The injection pressure is about 2 bar to about 4 bar, and the temperature of the resin during the injection process can be maintained at about 290° C. to about 320° C. The thickness of the resin member 57 can be changed according to the need of the composite 500.

The resin member 57 can be made of a thermoplastic or a thermosetting plastic.

The thermoplastic can be selected from a group consisting of polybutylene terephthalate (PBT), polyphenylene sulfide (PPS), polyethylene terephthalate (PET), polyether ether ketone (PEEK), polycarbonate (PC) and polyvinyl chloride polymer (PVC).

The thermosetting plastic can be selected from a group consisting of polyurethane resin, epoxy, polyurea resin and acrylic resin.

The polyurethane resin can be referred to an organic compound having a plurality of —NHCOO groups at the main chain of the organic compound, or a product of an addition polymerization reaction of a diisocyanate or polyisocyanate with a compound having at least two hydroxides. Besides the —NHCOO groups, the polyurethane resin also has groups, such as C—O—C groups, C—O—O—C groups, N—CO—N groups, biuret groups, allophanate groups, and so on.

The epoxy can be referred to an organic compound having at least two epoxy groups.

The polyurea resin can be referred to as an elastomer formed by a reaction of an isocyanate with a resin. The polyurea resin can be an aliphatic compound, an aromatic compound, a monomer, a polymer, a derivative of isocyanate, a semi-prepolymer of isocyanate or a prepolymer of isocyanate. The semi-prepolymer of isocyanate and the prepolymer of isocyanate can be made by a reaction of an isocyanate with a compound having an amino group or a hydroxy group at one terminal of the compound.

The acrylic resin can have at least two groups, and can be cured by a UV cross-linking reaction.

It is to be understood, a defined amount of curing agent or photo-initiator should be added into the thermosetting plastic when the resin member 57 is made of the thermosetting plastic. When liquid thermosetting plastic having curing agent or photo-initiator is filled into the micro-pores 591 and covers the surface of the metal layer 59, the thermosetting plastic can be hardened, forming the resin member 57.

Tensile and shear strength tests were applied to the composite 500. The results show that the tensile strength of the composite 100 can reach 3 MPa to about 8 MPa, and the shear strength of the composite can reach 6 MPa to about 30 MPa. After repeated cold and hot shock testing for 48 hours at temperatures in a range of −40° C. to 85° C., in 4 hour cycles, the tensile and shear strength of the composite 500 do not become notably weaker.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A metal-resin composite comprising:
a metal member having a plurality of metal posts on a surface of the metal member; and
a resin member being filled in spaces between adjacent metal posts and covering the surface of the metal member to bond with the metal member.

2. The metal-resin composite as claimed in claim 1, wherein each metal post has a diameter of about 0.01 mm to about 1 mm, and the length of each metal post is about 2 μm to about 15 μm along a direction extending from the metal member to the resin member.

3. The metal-resin composite as claimed in claim 2, wherein each end of the metal posts away from the metal member further has a metal lug connected with a corresponding metal post, the thickness of each metal lug is about 4 μm to about 8 μm, the resin member is filled the spaces between adjacent metal posts and covers the surface of the metal member and the metal lugs to bond with the metal member.

4. The metal-resin composite as claimed in claim 1, wherein each metal post has a diameter of about 0.01 mm to about 1 mm, the length of each metal post is about 2 μm to about 20 μm along a direction extending from the metal member to the resin member, and the surface roughness of each metal post is about 2.0 μm to about 5.0 μm.

5. The metal-resin composite as claimed in claim 4, wherein each end of the metal posts away from the metal member further has a metal lug connected with a corresponding metal post, the thickness of each metal lug is about 4 μm to about 8 μm, the surface roughness of the metal posts is about 2.0 μm to about 5.0 μm, the resin member is filled the spaces between adjacent metal posts and covers the surface of the metal member and the metal lugs to bond with the metal member.

6. The metal-resin composite as claimed in claim 4, wherein the metal posts and the metal lugs are both selected from a group consisting of Au, Ag, Cu, Ni, Zn, Sn, Al and Cr.

7. The metal-resin composite as claimed in claim 4, wherein the metal member is selected from a group consisting of stainless steel, aluminum, aluminum alloy, magnesium, magnesium alloy, copper, copper alloy, zinc and zinc alloy.

8. The metal-resin composite as claimed in claim 4, wherein the resin member is selected from a group consisting of polybutylene terephthalate, polyphenylene sulfide, polyethylene terephthalate, polyether ether ketone, polycarbonate, polyvinyl chloride polymer, polyurethane resin, epoxy, polyurea resin and acrylic resin.

9. A metal-resin composite comprising:
a metal member, the metal member having a metal layer, the metal layer defining a plurality of micro-pores; and
a resin member, the resin member being filled into the micro-pores and covering the metal layer to bond with the metal member.

10. The metal-resin composite as claimed in claim 9, wherein the metal layer is selected from a group consisting of Au, Ag, Cu, Ni, Zn, Sn, Al and Cr.

11. The metal-resin composite as claimed in claim 9, wherein the surfaced roughness of the metal layer is about 2.0 μm to about 5.0 μm, the thickness of the metal layer is about 2 μm to about 20 μm.

12. The metal-resin composite as claimed in claim 9, wherein the diameter of the micro-pores is about 1 μm to about 50 μm.

13. A method for making a metal-resin composite comprising:
providing a metal member;
forming a shield layer on the metal member;
forming a plurality of holes on the shield layer, the metal member being exposed from the holes;
forming a plurality of metal posts in the holes;
the shield layer being removed from the surface of the metal member; and
liquid resin being filled into spaces between adjacent metal posts and covering the surface of the metal member to bond with the metal member.

14. The method as claimed in claim 13, wherein the method for making a metal-resin composite further includes a step of forming a plurality of metal lugs correspondingly on ends of the metal posts away from the metal member, the thickness of each metal lug is about 4 μm to about 8 μm, the resin member is filled the spaces between adjacent metal posts and covers the surface of the metal member and the metal lugs to bond with the metal member.
